(19) United States
(12) Patent Application Publication
(10) Pub. No.: US 2018/0368561 A1
(43) Pub. Date: Dec. 27, 2018

(54) SCISSOR HOLSTER

(71) Applicant: Bradley James BOND, Scarborough (AU)

(72) Inventor: Bradley James BOND, Scarborough (AU)

(21) Appl. No.: 16/061,957

(22) PCT Filed: Mar. 10, 2017
(86) PCT No.: PCT/AU2017/050217

§ 371 Date: Jun. 13, 2018

(30) Foreign Application Priority Data
Mar. 11, 2016 (AU) 2016900916

(51) Int. Cl. A45F 5/02; B26B 29/04

(52) U.S. Cl. CPC A45F 5/021; A45F 2200/0575; B26B 29/04

(57) ABSTRACT

A holster for carrying heavy duty or industrial scissors on a user's belt. The scissors having a pair of handles and cutting blades. The holster includes a front panel and a back panel, the front panel being secured to the back panel to define therebetween a pouch having an opening and an oppositely disposed closed end. The cutting blades of the scissors are insertable through the opening of the pouch. The holster further includes restraining means, which may be in the form of a restraining rivet, for preventing an end tip of the cutting blades contacting the closed end of the pouch when the scissors are placed into the pouch.

### RELATED APPLICATIONS

The present application is a National Phase entry of PCT Application No. PCT/AU2017/050217, filed Mar. 10, 2017, which claims priority from AU Application No. 2016900916, filed Mar. 11, 2016, said applications being hereby incorporated by reference herein in their entirety.

### FIELD OF THE INVENTION

The present invention relates to a holster for carrying a cutting implement. More particularly, the present invention relates to a holster for carrying a pair of hand-operated scissors. As the holster is particularly suited for carrying industrial or heavy duty scissors (otherwise known as ‘industrial shears’) used for cutting carpet, fabric, upholstery or the like, it will be convenient to primarily describe the invention with reference to this particular type of scissors. It should however be understood that the invention can also be used for other types of scissors.

### BACKGROUND TO THE INVENTION

Hand-operated scissors are commonly used for cutting a wide variety of materials. Scissors are generally sized and shaped according to their intended use. Small scissors are typically of lightweight construction and are designed for cutting relatively thin materials such as paper and cardboard. For cutting through tougher materials such as carpet, fabric, upholstery and the like, larger scissors of heavy duty construction are required.

Heavy duty or industrial scissors designed for cutting carpet, fabric and upholstery typically have thick, heavy duty blades and an overall length of approximately 30 cm (12 inches). It is common for some workers in the carpet, fabric and upholstery industries to carry this type of scissors in a rear or side trouser pocket for easy access. In this respect, the scissors are often placed handles first in the pocket with the tip of the scissors facing upwards. This is a particularly dangerous practice as the tip of the scissors is sharp and could easily injure the worker, for example in the event of a fall.

It would be desirable to provide a device for carrying scissors in a safe and convenient manner.

### SUMMARY OF THE INVENTION

In accordance with the present invention, there is provided a holster for carrying scissors having a pair of handles and cutting blades, the holster including a front panel and a back panel, the front panel being secured to the back panel to define therebetween a pouch having an opening and an oppositely disposed closed end, the cutting blades of the scissors being insertable through the opening of the pouch, the holster further including restraining means for preventing an end tip of the cutting blades contacting the closed end of the pouch, when the scissors are placed into the pouch.

The restraining means is preferably connected to the front panel and the back panel. The restraining means is preferably positioned to reduce the size of the opening of the pouch such that, when the scissors are placed into the pouch, the handles are at least in part prevented from entering the pouch. The restraining means is preferably in the form of a rivet which extends through the front and back panels.

In a preferred embodiment, the front panel is formed of a folded over flap which is integral with the back panel. An edge of the folded flap is secured to an overlying edge of the back panel with stitching, thereby forming said pouch.

The holster preferably further includes an auxiliary panel secured to the front panel to define therebetween a utility pocket overlying the pouch. The utility pocket has an opening and an oppositely disposed closed end. An edge of the auxiliary panel is preferably secured to an overlying edge of the front panel with stitching, thereby forming the utility pocket.

The auxiliary panel preferably has a width which is greater than the front panel such that the opening of the utility pocket hangs away from the front panel.

The holster may further include a reinforcement material at the closed end of the pouch between the front panel and the back panel.

The holster may further include a belt attachment means for enabling the holster to be worn on a user's belt. In this respect, the belt attachment means is preferably formed by a folded over portion of the back panel. An end of the folded over portion may be secured to the back panel to form a belt loop for receiving a user's belt. The end of the folded over portion is preferably secured to the back panel by a series of belt loop rivets which are substantially aligned with the opening of the pouch.

To assist the further understanding of the invention, reference will now be made to the accompanying drawings which illustrate preferred embodiments. It is to be appreciated that these embodiments are given by way of illustration only and the invention is not to be limited by this illustration.

### BRIEF DESCRIPTION OF THE DRAWINGS

FIG. 1 is a front view of a holster worn on the belt of a user, the holster containing a pair of scissors, in accordance with an embodiment of the invention.

FIG. 2 is a perspective view of the front side of the holster shown in FIG. 1.

FIG. 3 is a perspective view of the rear side of the holster shown in FIG. 1.

FIG. 4 is a further perspective view of the front side of the holster shown in FIG. 1.

FIGS. 5a and 5b are templates detailing the dimensions and shape of leather required in the construction of a holster 1 specifically suitable for 10 inch and 12 inch Wiss® industrial scissors, respectively.

### DESCRIPTION OF PREFERRED EMBODIMENTS

With reference to the accompanying figures, there is shown a holster 1 for carrying a pair of scissors 3 on a user's belt 5. The holster 1 is preferably made of a pliable material having high strength and wearability. In this regard, the pliable material is preferably leather which for decorative purposes may have a marble effect. The leather preferably has a thickness between approximately 2.2 mm and 2.8 mm. The preferred leather thickness depends upon the scissors 3 the holster 1 is intended for.

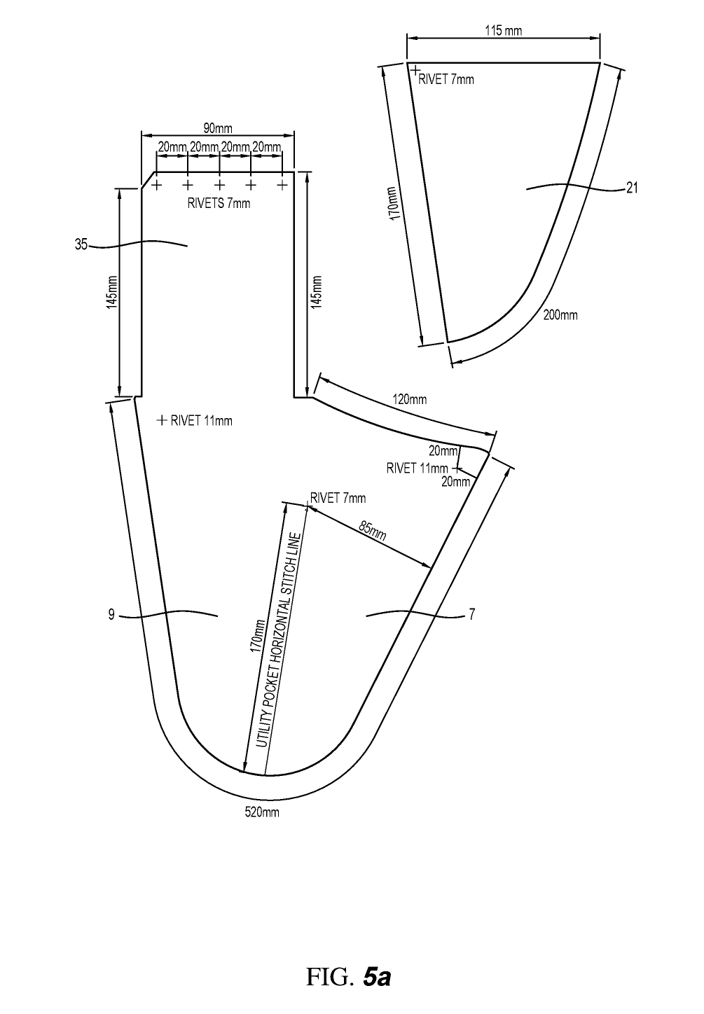

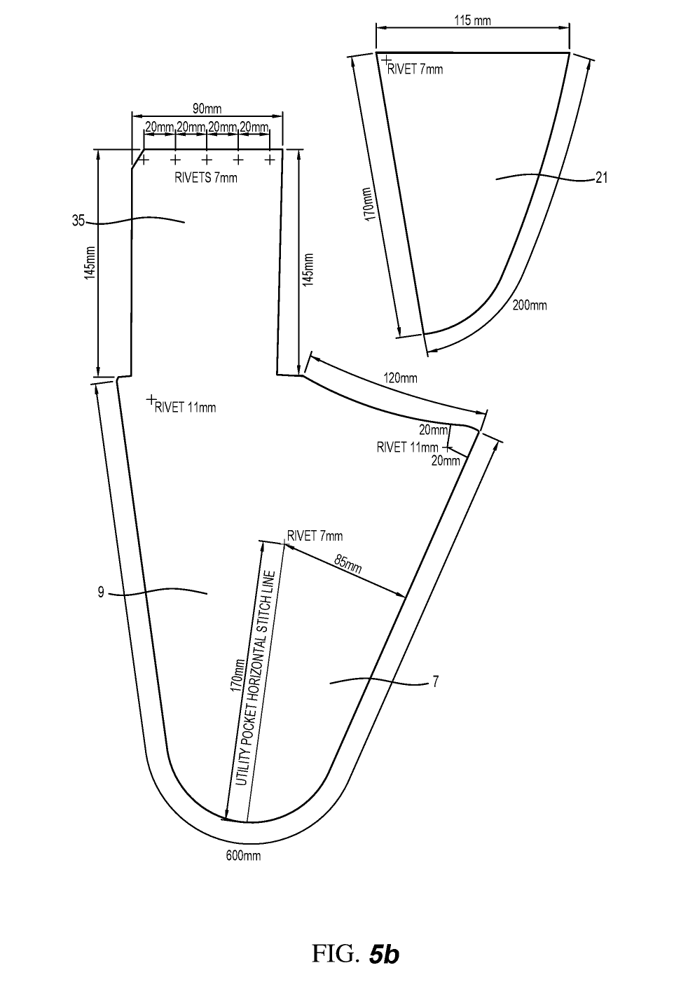

The holster 1 includes a front panel 7 and a back panel 9. The front panel 7 is secured to the back panel 9 to define therebetween a pouch 11 for carrying the scissors 3. In this respect, the front panel 7 is preferably formed of a folded flap which is integral with the back panel 9, as shown in FIGS. 5a and 5b. The folded flap forming the front panel 7 is positioned such that an edge of the folded flap overlies an edge of the back panel with the overlying edges being stitched together to form the pouch 11.

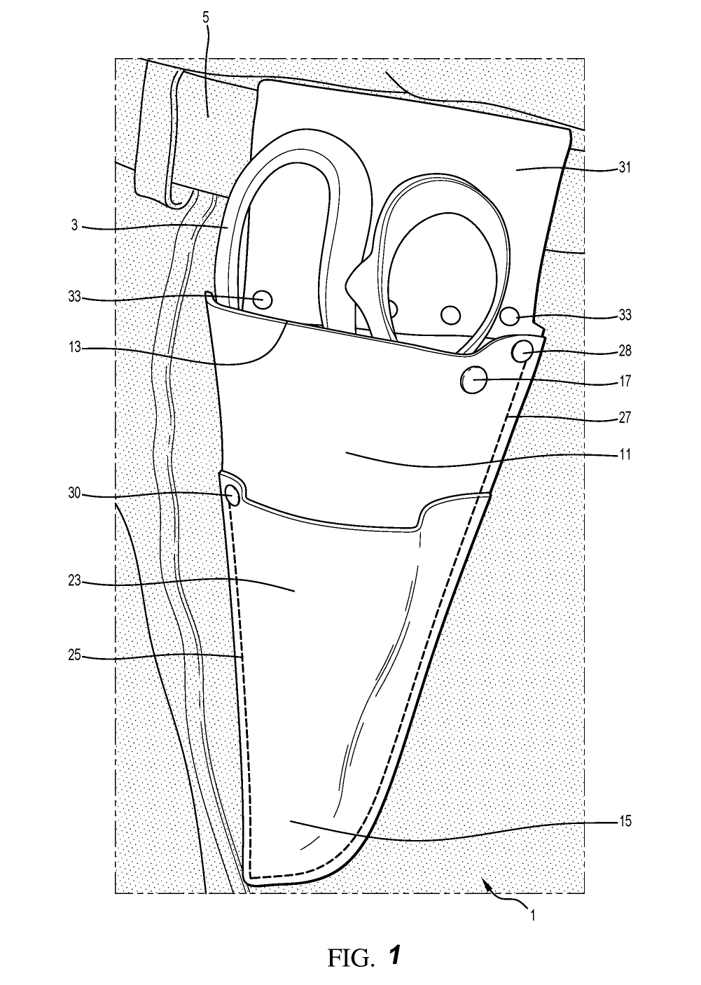

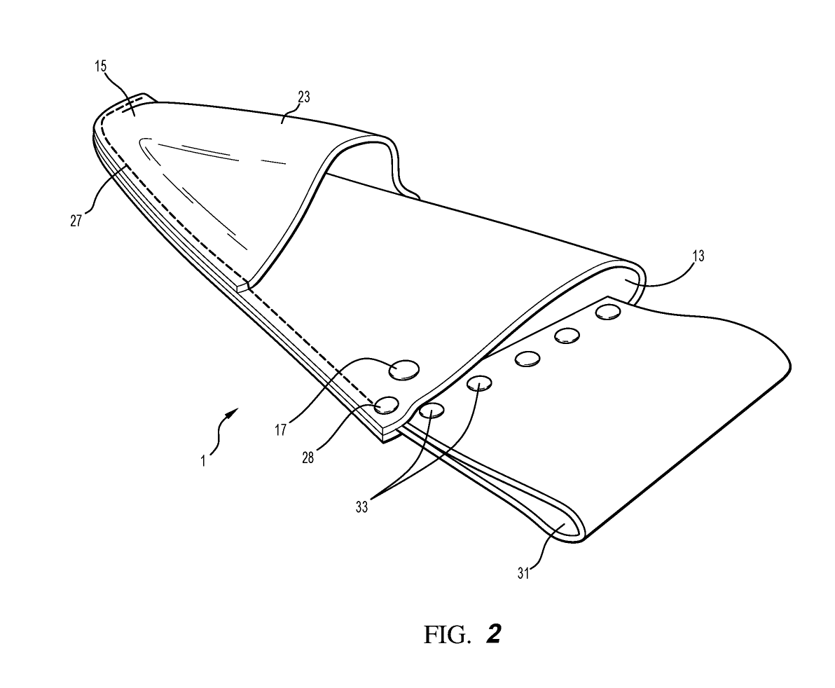

The pouch 11 includes an opening 13 at one end and an oppositely disposed closed end 15. In order to prevent the end tip of scissors 3 carried in the pouch 11 from contacting the bottom/closed end 15, the holster 1 further includes restraining means. The restraining means is preferably in the form of a restraining rivet 17 which preferably extends through the front panel 7 and the back panel 9. The restraining rivet 17 is advantageously positioned to reduce the size of the opening 13 of the pouch 11 such that, when the scissors 3 are in the pouch 11, the handles of the scissors 3 are at least in part prevented from entering the pouch 11 further than necessary and the end tip of the scissors 3 is not able to contact and cause wear to the bottom of the pouch 11. In other words, the restraining rivet 17 holds the scissors 3 back from fully entering the pouch 11 such that the handles of the scissors 3 remain at least partly outside of the pouch 11, as can be seen in FIG. 1. The restraining rivet 17 can be approximately 8 mm in diameter and advantageously positioned approximately 20 mm in from the outside edge of the front panel 7 and approximately 20 mm down from a top edge of the front panel 7. The restraining rivet 17 advantageously ensures that the end tip of the scissors 3 is not able to contact the bottom of the pouch 11.

The holster 1 further includes an auxiliary panel 21 secured to the front panel 7 to define therebetween a utility pocket 23 which overlies the pouch 11. The utility pocket 23 is designed for items such as pens, pencils and the like. The utility pocket 23 preferably has a length of approximately 170 mm and a width at the top of approximately 115 mm. The auxiliary panel 21 forming the utility pocket 23 preferably has a width which is greater than the front panel 7, as shown in FIGS. 5a and 5b. This ensures that the opening of the utility pocket 23 hangs away from the front panel 7 enabling easier access to the contents of the utility pocket 23. The auxiliary panel 21 is preferably stitched to the underlying front panel 7. In this respect, the holster 1 includes a straight side edge of stitching 25 at one side of the holster 1 and a curved side edge of stitching 27 at the other. The curved side edge of stitching 27 passes through the auxiliary panel 21, the front panel 7 and the back panel 9. The straight side edge of stitching 25 passes through the auxiliary panel 21 and the front panel 7. The stitches are each approximately 5 mm apart and the thread used for the stitching is preferably a UV treated/bonded polyester thread having a 135 gauge thickness for longevity.

In order to reinforce the opening 13 of the pouch 11, a pouch reinforcement rivet 28 is preferably positioned at the end of the curved side edge of stitching 27. Similarly, a utility pocket reinforcement rivet 30 is preferably positioned at the end of the straight side edge of stitching 25 to reinforce the opening of the utility pocket 23 and prevent separation of the auxiliary panel 21 from the front panel 7 over the lifetime of the holster 1. Both reinforcement rivets 28, 30 are preferably 5 mm rivets made of brass.

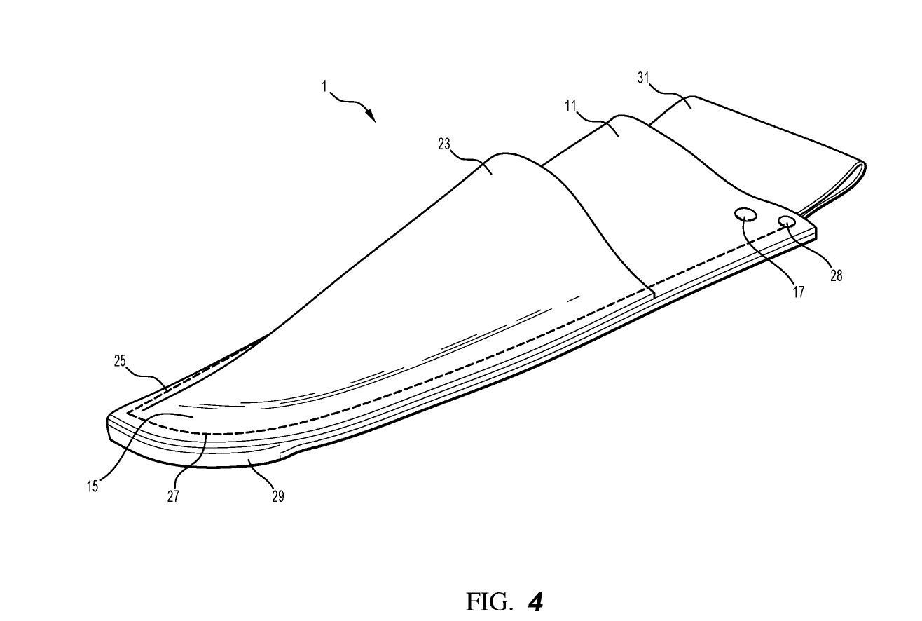

As best shown in FIG. 4, the holster 1 may further include a reinforcement material 29 at the bottom/closed end 15 of the pouch 11. The reinforcement material 29 is preferably a piece of leather positioned between the front panel 7 and the back panel 9 at the base of the holster 1. In this respect, the reinforcement material 29 is preferably sewn in position by the curved side edge of stitching 27 and the straight side edge of stitching 25. The piece of leather used for the reinforcement material 29 may be approximately 50 mm by 20 mm and contoured to the shape of the closed end 15 of the pouch 11. The reinforcement material 29 is an additional preventative measure to avoid a hole being created in the bottom of the holster 1.

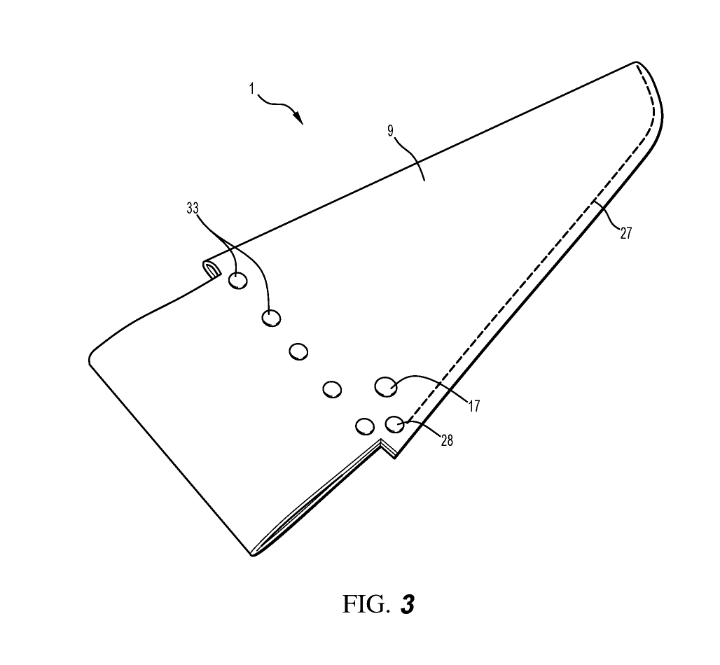

Preferably, the holster 1 further includes a belt attachment means for attaching the holster 1 onto a user's belt 5. The belt attachment means is preferably formed of an extended piece 35 of the back panel 9, as shown in FIGS. 5a and 5b, which is folded over. An end of the folded over portion is secured to the back panel 9 to form a belt loop 31 through which the user's belt 5 is inserted. The belt loop 31 is preferably about 60 mm wide to ensure that the belt loop 31 is suitable for belts of up to 55 mm in width. The end of the folded over portion is preferably secured to the back panel 9 by a series of belt loop rivets 33 which are substantially aligned with the opening 13 of the pouch 11. As shown in FIG. 3, the belt loop rivets 33 are preferably positioned approximately 20 mm apart and may be of brass construction. The belt loop rivets 33 function to prevent separation of the folded over portion from the back panel 9. Alternatively, stitching could be utilised rather than the belt loop rivets 33, however, rivets are preferred for strength, durability and longevity.

The holster 1 is particularly suited for industrial scissors, for example Wiss® W20W 10 inch and W22W 12 inch bent handle, wide blade industrial scissors which are commonly used in the carpet, fabric and upholstery industries. In this respect, FIGS. 5A and 5B illustrate a template providing details of the dimensions and shape of the leather required in the construction of a holster 1 specifically suitable for the 10 inch and 12 inch Wiss® industrial scissors, respectively. The holster 1 is also able to be adapted to suit virtually any commercial and industrial scissor, particularly those ranging from 7 to 12 inches in size.

Although the preferred features of the invention have been described herein in detail, it will be understood by those skilled in the art that variations may be made thereto without departing from the spirit of the invention or the scope of the appended claims.

1. A holster for carrying scissors having a pair of handles and cutting blades, the holster including a front panel and a back panel, the front panel being secured to the back panel to define therebetween a pouch having an opening and an oppositely disposed closed end, the cutting blades of the scissors being insertable through the opening of the pouch, the holster further including restraining means for preventing an end tip of the cutting blades contacting the closed end of the pouch, when the scissors are placed into the pouch.

2. A holster as claimed in claim 1 wherein the restraining means is connected to the front panel and the back panel, the restraining means being positioned to reduce the size of the opening of the pouch such that, when the scissors are placed into the pouch, the handles are at least in part prevented from entering the pouch.

3. A holster as claimed in claim 2 wherein the restraining means is a rivet extending through the front and back panels.

4. A holster as claimed in claim 1 wherein the front panel is formed of a folded flap integral with the back panel, an edge of the folded flap being secured to an overlying edge of the back panel with stitching, thereby forming said pouch.

5. A holster as claimed in claim 1 further including an auxiliary panel secured to the front panel to define therebetween a utility pocket overlying the pouch, the utility pocket having an opening and an oppositely disposed closed end.

6. A holster as claimed in claim 5 wherein an edge of the auxiliary panel is secured to an overlying edge of the front panel with stitching, thereby forming said utility pocket.

7. A holster as claimed in claim 6 wherein the auxiliary panel has a width which is greater than the front panel such that the opening of the utility pocket hangs away from the front panel.

8. A holster as claimed in claim 1 further including a reinforcement material at the closed end of the pouch between the front panel and the back panel.

9. A holster as claimed in claim 1 further including belt attachment means for enabling the holster to be worn on a user's belt.

10. A holster as claimed in claim 9 wherein the belt attachment means is formed by a folded over portion of the back panel, an end of the folded over portion being secured to the back panel to form a belt loop for receiving a user's belt.

11. A holster as claimed in claim 10 wherein the end of the folded over portion is secured to the back panel by a series of rivets substantially aligned with the opening of the pouch.

12. A holster as claimed in claim 2 wherein the front panel is formed of a folded flap integral with the back panel, an edge of the folded flap being secured to an overlying edge of the back panel with stitching, thereby forming said pouch.

13. A holster as claimed in claim 3 wherein the front panel is formed of a folded flap integral with the back panel, an edge of the folded flap being secured to an overlying edge of the back panel with stitching, thereby forming said pouch.

14. A holster as claimed in claim 2 further including an auxiliary panel secured to the front panel to define therebetween a utility pocket overlying the pouch, the utility pocket having an opening and an oppositely disposed closed end.

15. A holster as claimed in claim 3 further including an auxiliary panel secured to the front panel to define therebetween a utility pocket overlying the pouch, the utility pocket having an opening and an oppositely disposed closed end.

16. A holster as claimed in claim 4 further including an auxiliary panel secured to the front panel to define therebetween a utility pocket overlying the pouch, the utility pocket having an opening and an oppositely disposed closed end.

17. A holster as claimed in claim 12 further including an auxiliary panel secured to the front panel to define therebetween a utility pocket overlying the pouch, the utility pocket having an opening and an oppositely disposed closed end.

18. A holster as claimed in claim 13 further including an auxiliary panel secured to the front panel to define therebetween a utility pocket overlying the pouch, the utility pocket having an opening and an oppositely disposed closed end.

19. A holster as claimed in claim 2 further including a reinforcement material at the closed end of the pouch between the front panel and the back panel.

20. A holster as claimed in claim 2 further including belt attachment means for enabling the holster to be worn on a user's belt.
